(19) United States
(12) Patent Application Publication
(10) Pub. No.: US 2026/0094762 A1
(43) Pub. Date: Apr. 2, 2026

(54) MAGNETIC DATA INTERFACE

(71) Applicant: Apple Inc., Cupertino, CA (US)

(72) Inventors: Grant S. Haug, Mountain View, CA (US); Jorge L. Rivera Espinoza, Los Gatos, CA (US); Xiaofang Mu, San Jose, CA (US); Behzad Tavassoli Hozouri, Sunnvale, CA (US); Xiaojie Fu, San Jose, CA (US)

(73) Assignee: Apple Inc., Cupertino, CA (US)

(21) Appl. No.: 19/340,434

(22) Filed: Sep. 25, 2025

Related U.S. Application Data
(60) Provisional application No. 63/700,135, filed on Sep. 27, 2024.

(51) Int. Cl. H01F 38/14; G06F 1/16; H02J 50/10; H02J 50/80

(52) U.S. Cl. CPC H01F 38/14; G06F 1/1698; H02J 50/10; H02J 50/80; H01F 2038/143

(57) ABSTRACT

Circuits, methods, and apparatus for interfaces for electronic devices that can support wireless communications. One example can provide electronic devices and corresponding charging devices having interfaces that include one or more antennas. These interfaces can further include one or more magnets. The antennas in the electronic devices and charging devices can be aligned with each other when the one or more magnets in the electronic device are attracted to and aligned with the corresponding one or more magnets in the charging device. These interfaces can further include charging coils for transferring power from a charging device to an electronic device.

### CROSS-REFERENCES TO RELATED APPLICATIONS

This application claims the benefit of U.S. Provisional Application No. 63/700,135, filed on Sep. 27, 2024, which is incorporated by reference.

### BACKGROUND

The number of types of electronic devices that are commercially available has increased tremendously the past few years and the rate of introduction of new devices shows no signs of abating. Devices such as tablet computers, laptop computers, all-in-one computers, desktop computers, cell phones, storage devices, wearable-computing devices, portable media players, navigation systems, monitors, adapters, and others, have become ubiquitous.

These electronic devices can communicate with each other over cables that have connectors on each end, where each connector can be inserted into receptacles on the communicating devices. Conductors in the cable can connect to pins or contacts in the connectors at each end. These pins or contacts can physically and electrically connect to pins or contacts in the connector receptacles.

But these receptacles can form ingress paths for liquids and moisture to enter an electronic device. Also, dust and debris can enter the receptacles and degrade a connection between the connector of the cable and the receptacle of the electronic device. Accordingly, it can be desirable to replace or supplement these receptacles.

Thus, what is needed are circuits, methods, and apparatus that can provide data interfaces for electronic devices that can support wireless communications.

### SUMMARY

Accordingly, embodiments of the present invention can provide circuits, methods, and apparatus for interfaces for electronic devices that can support wireless communications. An illustrative embodiment of the present invention can provide electronic devices and corresponding charging devices having interfaces that include one or more antennas. These interfaces can further include one or more magnets. The antennas in the electronic devices and charging devices can be aligned with each other when the one or more magnets in the electronic device are attracted to and aligned with the corresponding one or more magnets in the charging device. These interfaces can further include charging coils for transferring power from a charging device to an electronic device. The magnets in the electronic device and the charging device can also help to align the charging coil in an electronic device with the charging coil in the charging device to improve charging efficiency.

These and other embodiments of the present invention can provide other interfaces that include charging coils for power transfer. The waveforms used for power transfers can be modulated and used to transmit and receive power. A charging coil can be shielded by a ferrite. The ferrite can be positioned under the charging coil and can extend into a center opening in the charging coil. One or more antennas can be placed in the center opening of the charging coil. The ferrite can be removed from around and under the one or more antennas, or the ferrite can remain under the one or more antennas. These interfaces can include one or more magnets. One or more magnets in a charging device can be attracted to one or more corresponding magnets in an electronic device. This can help to align the one or more antennas in the charging device with the one or more antennas in the electronic device for efficient communications. These magnets can also help to align the charging coil in the charging device with the charging coil in the electronic device for efficient inductive charging. These magnets can be arranged as magnet arrays around a charging coil in each of an electronic device and a charging device in an electronic system.

These and other embodiments of the present invention can provide interfaces having a single antenna. When a single antenna is included, data communications can be half-duplex between a charging device and an electronic device. These and other embodiments of the present can provide interfaces having two antennas for full duplex operation. In this configuration, the two antennas can be placed in an opening of a charging coil for each of the charging device and electronic device. This can allow full-duplex communication where one antenna in each interface provides a receive path for the electronic device and the other antenna in each interface provides a transmit path for the electronic device.

In one example, an electronic device can include a first antenna that is approximately centered in an opening of a charging coil. A second antenna can be placed on an opposite side of the charging coil and magnet array as the first antenna. A charging device can include a first antenna that is approximately centered in an opening of a charging coil. A second antenna can be placed on an opposite side of the charging coil and magnet array as the first antenna. Data can be shared over the second antennas when the second antenna of the electronic device is aligned with the second antenna of the charging device. The electronic device can further include a second magnet positioned on the opposite side of the charging coil and magnet array as the first antenna. The charging device can further include a second magnet positioned on the opposite side of the charging coil and magnet array as the first antenna. The second magnet of the electronic device can attract the second magnet of the charging device thereby aligning the second antenna of the electronic device with the second antenna of the charging device.

In these and other embodiments of the present invention, the electronic device can further include a third and a fourth magnet, while the charging device can further include a third and a fourth antenna. When the second magnet on the charging device is aligned with one of the second, third, or fourth magnets of the electronic device, the second antenna of the electronic device can be aligned with one of the second, third, or fourth antennas of the charging device.

In these and other embodiments of the present invention, the charging device can further include a third and a fourth magnet, while the electronic device can further include a third and a fourth antenna. When the second magnet on the electronic device is aligned with one of the second, third, or fourth magnets of the charging device, the second antenna of the charging device can be aligned with one of the second, third, or fourth antennas of the electronic device.

In another example, an electronic device can include a first antenna that is approximately centered in an opening of a charging coil. A second antenna can be placed in the opening of the charging coil and proximate to the first antenna. A charging device can include a first antenna that is approximately centered in an opening of a charging coil. A second antenna can have an annular shape and can laterally surround the first antenna. In this configuration, the first antenna of the electronic device can communicate with the first antenna of the charging device, while the second antenna of the electronic device can communicate with the second antenna of the charging device.

In another example, a charging device can include a first antenna that is approximately centered in an opening of a charging coil. A second antenna can be placed in the opening of the charging coil and proximate to the first antenna. An electronic device can include a first antenna that is approximately centered in an opening of a charging coil. A second antenna can have an annular shape and can laterally surround the first antenna. In this configuration, the first antenna of the electronic device can communicate with the first antenna of the charging device, while the second antenna of the electronic device can communicate with the second antenna of the charging device.

In these and other embodiments of the present invention, it can be desirable that the charging device be axisymmetric with the electronic device. That is, it can be desirable that the charging device be able to communicate with the electronic device regardless of the rotation of the charging device relative to the electronic device. To support this, each of the first antenna and second antenna in the charging device and electronic device can be circularly polarized. Alternatively, either a first antenna in the electronic device or a first antenna in the charging device can be circularly polarized, while the other is linearly polarized. Similarly, either a second antenna in the electronic device or a second antenna in the charging device can be circularly polarized, while the other can be circularly or linearly polarized.

In these and other embodiments of the present invention, an antenna can be formed of as an antenna array. The antenna array can provide a compact antenna system for use in electronic systems. The antenna array can be used for half duplex, full duplex, or other type of communications. The antenna can be a patch antenna or other type of antenna. The antenna can support Near-Field communications, wireless Universal Serial Bus Type-C, or other high-speed wireless communications. The antennas and other components of the electronic systems shown herein can provide multilane traffic of 10 GB, 20 GB, 30 GB, or other data rates per lane.

Two, four, or more than four antenna elements can be included in the antenna array. The antenna elements can be circularly polarized with the same hand polarization, though the antenna elements can have different polarizations in these and other embodiments of the present invention. The antenna array can provide a high isolation by incorporating geometrical symmetry, which can help to reduce a sensitivity to the electromagnetic performance of the antenna elements.

Pairs of diagonally arranged antenna elements can operate in a differential feed configuration. Each pair can be used for transmitting or receiving. For example, pairs of antenna elements can operate in a differential feed configuration.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system according to an embodiment of the present invention;

FIG. 2 illustrates a variation on the electronic system of FIG. 1;

FIG. 3 illustrates another electronic system according to an embodiment of the present invention;

FIG. 4 illustrates a variation on the electronic system of FIG. 3;

FIG. 5 is a cutaway side view of an electronic device according to an embodiment of the present invention;

FIG. 6 is a cutaway side view of a charging device according to an embodiment of the present invention; and

FIG. 7 illustrates an antenna according to an embodiment of the present invention.

### DESCRIPTION OF ILLUSTRATIVE EMBODIMENTS

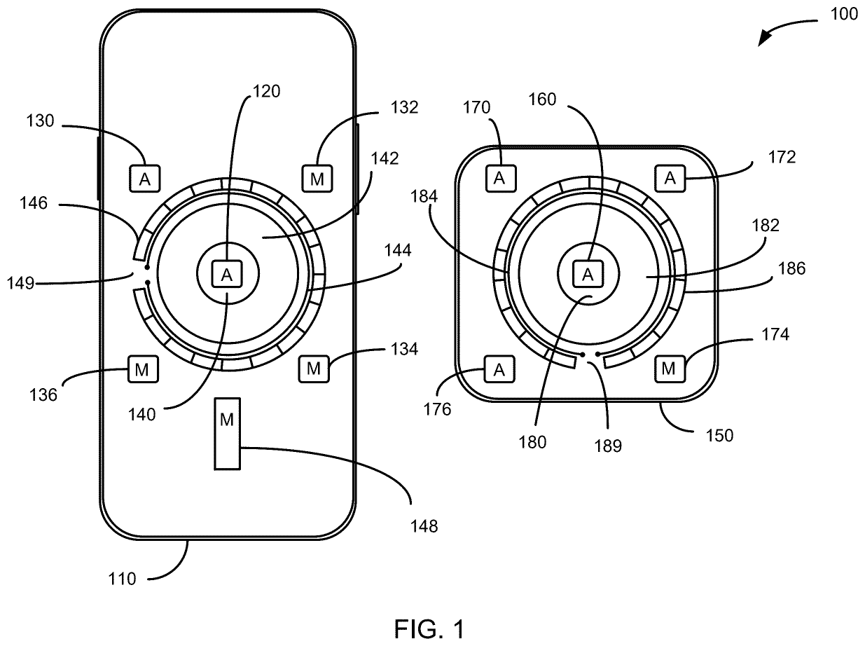

FIG. 1 illustrates an electronic system according to an embodiment of the present invention. This figure, as with the other included figures, is shown for illustrative purposes and does not limit either the possible embodiments of the present invention or the claims.

Electronic system 100 can include electronic device 110 and charging device 150. Electronic device 110 can include charging coil 142, near-field communication component 144, and magnet array 146. Charging device 150 can include charging coil 182, near-field communication component 184, and magnet array 186. Charging coil 182 of charging device 150 can transfer power to charging coil 142 of electronic device 110. Magnet array 146 of electronic device 110 can align with magnet array 186 of charging device 150. This alignment can help to align charging coil 142 and charging coil 182 to improve power transfer. Near-field communication component 144 and near-field communication component 184 can enable additional communications between electronic device 110 and charging device 150.

Charging coil 142 of electronic device 110 can include central opening 140. Antenna 120 can be positioned in central opening 140. A ferrite (not shown) can be positioned under charging coil 142. This ferrite can include an opening for antenna 120, or the ferrite can extend under some or all of antenna 120. Charging coil 182 of charging device 150 can include central opening 180. Antenna 160 can be positioned in central opening 180. A ferrite (not shown) can be positioned under charging coil 182. This ferrite can include an opening for antenna 160, or the ferrite can extend under some or all of antenna 160.

Antenna 120 in electronic device 110 can align with antenna 160 in charging device 150 when magnet array 146 in electronic device 110 is aligned with magnet array 186 in charging device 150. A single antenna 120 in electronic device 110 and a single antenna 160 in charging device 150 can provide a half-duplex path. That is, data can be transferred from charging device 150 to electronic device 110, and then from electronic device 110 to charging device 150 in an alternating fashion.

In these and other embodiments of the present invention, it can be desirable to have two data paths, one providing a receive path and one providing a transmit path for electronic device 110. Accordingly, electronic device 110 can include a second antenna 130 and charging device 150 can include a second antenna 172. Second antenna 130 and second antenna 172 can form a second data path between electronic device 110 and the charging device 150 when second antenna 130 and second antenna 172 are aligned. To facilitate this alignment, electronic device 110 can include second magnet 136, while charging device 150 can include second magnet 174. When second magnet 136 and second magnet 174 are aligned and magnet array 146 and magnet array 186 are aligned, second antenna 130 and second antenna 172 can be aligned.

In these and other embodiments of the present invention, it can be desirable that charging device 150 be able to be oriented different ways with electronic device 110. Accordingly, electronic device 110 can include third magnet 132 and fourth magnet 134. This can allow second magnet 174 in charging device 150 to mate in any one of three orientations with second magnet 136, third magnet 132, or fourth magnet 134 in electronic device 110. Charging device 150 can include third antenna 170 and fourth antenna 176. In these positions, second antenna 130 of electronic device 110 can form a path with one of second antenna 172, third antenna 170, and fourth antenna 176 in charging device 150.

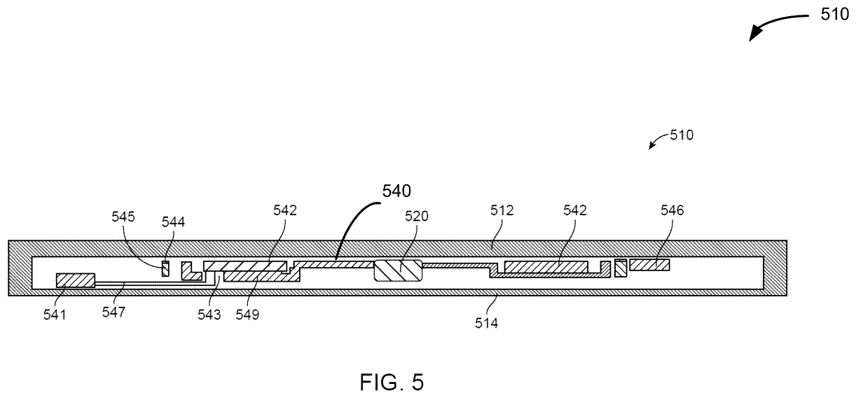

In these and other embodiments of the present invention, electronic device 110 can include an opening 149 in magnet array 146 and near-field communication component 144 for the routing of wires 547 (shown in FIG. 5.) Charging device 150 can include a similar opening 189. Electronic device 110 can include alignment magnet 148 that can be used when aligning to larger charging devices 150.

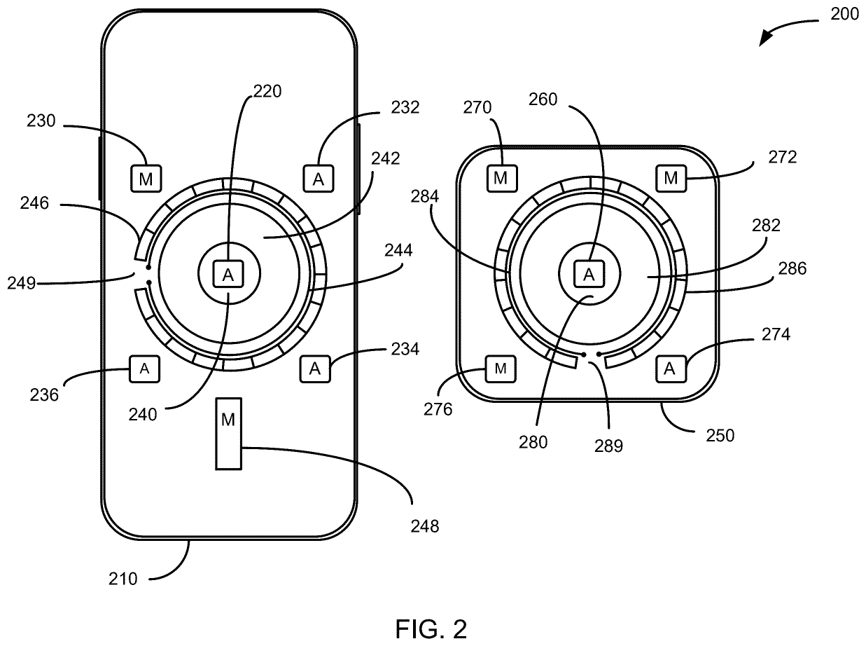

FIG. 2 illustrates a variation on the electronic system of FIG. 1. System 200 can include electronic device 210 and charging device 250. Electronic device 210 can include charging coil 242, near-field communication component 244, and magnet array 246. Charging device 250 can include charging coil 282, near-field communication component 284, and magnet array 286. Charging coil 282 of charging device 250 can transfer power to charging coil 242 of electronic device 210. Magnet array 246 of electronic device 210 can align with magnet array 286 of charging device 250. This alignment can help to align charging coil 242 and charging coil 282 to improve power transfer. Near-field communication component 244 and near-field communication component 284 can enable additional communications between electronic device 210 and charging device 250.

Charging coil 242 of electronic device 210 can include central opening 240. Antenna 220 can be positioned in central opening 240. A ferrite (not shown) can be positioned under charging coil 242. This ferrite can include an opening for antenna 220, or the ferrite can extend under some or all of antenna 220. Charging coil 282 of charging device 250 can include central opening 280. Antenna 260 can be positioned in central opening 280. A ferrite (not shown) can be positioned under charging coil 282. This ferrite can include an opening for antenna 260, or the ferrite can extend under some or all of antenna 260.

Antenna 220 in electronic device 210 can align with antenna 260 in charging device 250 when magnet array 246 in electronic device 210 is aligned with magnet array 286 in charging device 250. A single antenna 220 in electronic device 210 and a single antenna 260 in charging device 250 can provide a half-duplex path. That is, data can be transferred from charging device 250 to electronic device 210, and then from electronic device 210 to charging device 250 in an alternating fashion.

In these and other embodiments of the present invention, it can be desirable to have two data paths, one providing a receive path and one providing a transmit path for electronic device 210. Accordingly, electronic device 210 can include a second antenna 236 and charging device 250 can include a second antenna 274. Second antenna 236 and second antenna 274 can form a second data path between electronic device 210 and the charging device 250 when second antenna 236 and second antenna 274 are aligned. To facilitate this alignment, electronic device 210 can include second magnet 230, while charging device 250 can include second magnet 272. When second magnet 230 and second magnet 272 are aligned and magnet array 246 and magnet array 286 are aligned, second antenna 236 and second antenna 274 can be aligned.

In these and other embodiments of the present invention, it can be desirable that charging device 250 be able to be oriented different ways with electronic device 210. Accordingly, charging device 250 can include third magnet 270 and fourth magnet 276. This can allow second magnet 230 in electronic device 210 to mate in any one of three orientations with second magnet 272, third magnet 270, or fourth magnet 276. Electronic device 210 can include third antenna 232 and fourth antenna 234. In these positions, second antenna 274 of charging device 250 can form a path with one of second antenna 236, third antenna 232, and fourth antenna 234 in electronic device 210.

In these and other embodiments of the present invention, electronic device 210 can include an opening 249 in magnet array 246 and near-field communication component 244 for the routing of wires 547 (shown in FIG. 5.) Charging device 250 can include a similar opening 289. Electronic device 210 can include alignment magnet 248 that can be used when aligning to larger charging devices 250.

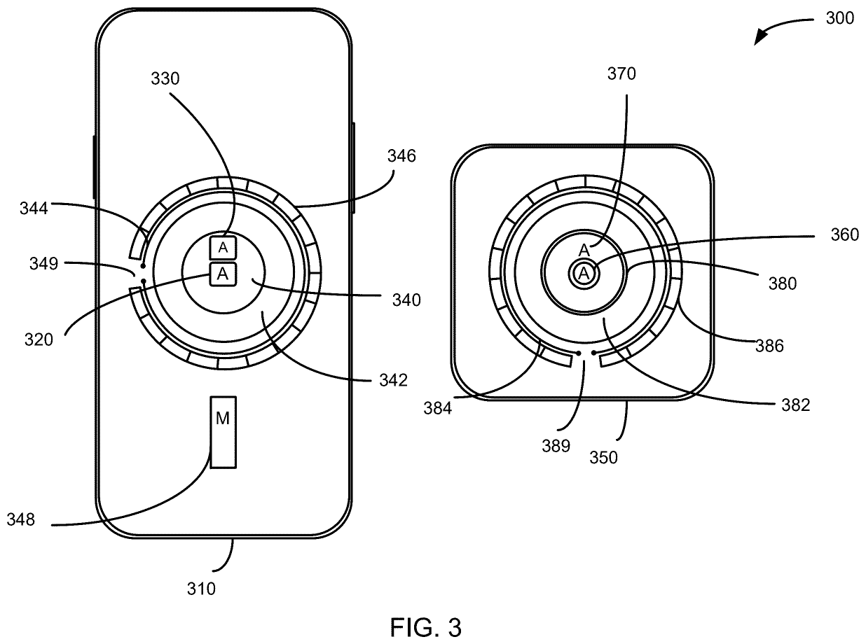

FIG. 3 illustrates another electronic system according to an embodiment of the present invention. System 300 can include electronic device 310 and charging device 350. Electronic device 310 can include charging coil 342, near-field communication component 344, and magnet array 346. Charging device 350 can include charging coil 382, near-field communication component 384, and magnet array 386. Charging coil 382 of charging device 350 can transfer power to charging coil 342 of electronic device 310. Magnet array 346 of electronic device 310 can align with magnet array 386 of charging device 350. This alignment can help to align charging coil 342 and charging coil 382 to improve power transfer. Near-field communication component 344 and near-field communication component 384 can enable additional communications between electronic device 310 and charging device 350.

Charging coil 342 of electronic device 310 can include central opening 340. Antenna 320 can be positioned in central opening 340. A ferrite (not shown) can be positioned under charging coil 342. This ferrite can include an opening for antenna 320, or the ferrite can extend under some or all of antenna 320. Charging coil 382 of charging device 350 can include central opening 380. Antenna 360 can be positioned in central opening 380. A ferrite (not shown) can be positioned under charging coil 382. This ferrite can include an opening for antenna 360, or the ferrite can extend under some or all of antenna 360.

Antenna 320 in electronic device 310 can align with antenna 360 in charging device 350 when magnet array 346 in electronic device 310 is aligned with magnet array 386 in charging device 350. A single antenna 320 in electronic device 310 and a single antenna 360 in charging device 350 can provide a half-duplex path. That is, data can be transferred from charging device 350 to electronic device 310, and then from electronic device 310 to charging device 350 in an alternating fashion.

In these and other embodiments of the present invention, it can be desirable to have two data paths, one providing a receive path and one providing a transmit path for electronic device 310. Accordingly, electronic device 310 can include a second antenna 330 and charging device 350 can include a second antenna 370. Second antenna 330 and second antenna 370 can form a second data path between electronic device 310 and charging device 350 when second antenna 330 and second antenna 370 are aligned. To facilitate the alignment between second antenna 330 and second antenna 370, second antenna 370 can be annular in shape such that second antenna 330 and second antenna 370 align regardless of the rotation of charging device 350 to electronic device 310. This can allow charging device 350 to be able to be oriented different ways at different angles with electronic device 310.

Antenna 320 and antenna 330 can be placed in other locations in electronic device 310. For example, antenna 320 and antenna 330 can be placed further away from each other. This can help to improve isolation between receive and transmit channels when one of antenna 320 and antenna 330 is receiving while the other is transmitting.

For example, antenna 320 and antenna 330 can both remain in central opening 340 with antenna 320 remaining centered in central opening 340. Antenna 320 and antenna 330 can be separated further apart by increasing a size of central opening 340, by decreasing a size of either or both antenna 320 and antenna 330, or by changing another dimension. In this configuration, a spacing between antenna 320 and antenna 330 can be increased. To compensate, a gap between antenna 360 and antenna 370 on charging device 350 can be increased as well. This arrangement can preserve rotational symmetry, allowing antenna 320 and antenna 330 of electronic device 310 and antenna 360 and antenna 370 of charging device 350 to be respectively mated at any rotational angle when magnet array 346 and magnet array 386 are aligned.

Alternatively, antenna 320 and antenna 330 can be placed further away from each other in central opening 340 of electronic device 310. For example, antenna 320 and antenna 330 can be on opposite sides of central opening 340. To compensate, antenna 370 can be made non-annular and antenna 360 and antenna 370 can be on opposite sides of central opening 380 of charging device 350. Rotational symmetry could be sacrificed but mitigated by the addition of one or more alignment magnets as in the examples of FIG. 1 and FIG. 2. For example, an alignment magnet corresponding to alignment magnet 348 in electronic device 310 can be added to charging device 350 to provide a specific orientation that aligns antenna 320 to antenna 360 and antenna 330 to antenna 370.

Alternatively, antenna 320 can remain in central opening 340 while antenna 330 can be moved between charging coil 342 and magnet array 346 on electronic device 310. To maintain rotational symmetry, antenna 330 can be annularly formed as a ring around charging coil 342.

To compensate, antenna 360 can remain in central opening 380, while antenna 370 can remain a ring though increased in size and positioned between charging coil 382 and magnet array 386. This arrangement can preserve rotational symmetry, allowing antenna 320 and antenna 330 of electronic device 310 and antenna 360 and antenna 370 of charging device 350 to be respectively mated at any rotational angle when magnet array 346 and magnet array 386 are aligned.

Alternatively, antenna 320 can remain in central opening 340 while antenna 330 can be moved outside of magnet array 346 on electronic device 310. To maintain rotational symmetry, antenna 330 can be annularly formed as a ring around magnet array 346. To compensate, antenna 360 can remain in central opening 380, while antenna 370 can remain a ring though increased in size and positioned around magnet array 386. This arrangement can preserve rotational symmetry, allowing antenna 320 and antenna 330 of electronic device 310 and antenna 360 and antenna 370 of charging device 350 to be respectively mated at any rotational angle when magnet array 346 and magnet array 386 are aligned.

Alternatively, both antenna 320 and antenna 330 can be moved outside of magnet array 346, for example on different sides of magnet array 346 on electronic device 310. To compensate, antenna 360 and antenna 370 can be moved outside of magnet array 386 to different sides of magnet array 386 on charging device 350. Rotational symmetry could be sacrificed but mitigated by the addition of one or more alignment magnets as in the examples of FIG. 1 and FIG. 2. For example, an alignment magnet corresponding to alignment magnet 348 in electronic device 310 can be added to charging device 350 to provide a specific orientation that aligns antenna 320 to antenna 360 and antenna 330 to antenna 370.

In these and other embodiments of the present invention, electronic device 310 can include an opening 349 in magnet array 346 and near-field communication component 344 for the routing of wires 547 (shown in FIG. 5.) Charging device 350 can include a similar opening 389. Electronic device 310 can include alignment magnet 348 that can be used when aligning to larger charging devices 350.

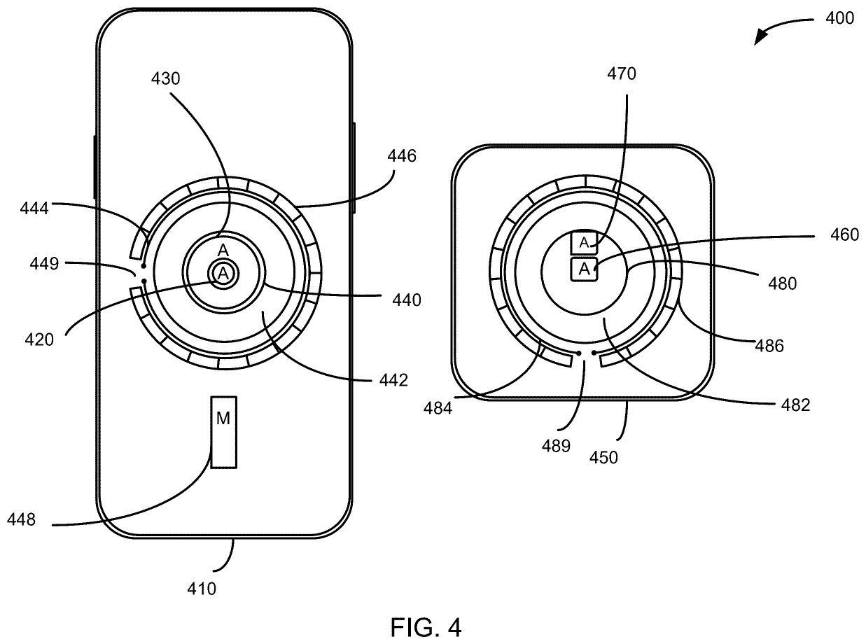

FIG. 4 illustrates a variation on the electronic system of FIG. 3. System 400 can include electronic device 410 and charging device 450. Electronic device 410 can include charging coil 442, near-field communication component 444, and magnet array 446. Charging device 450 can include charging coil 482, near-field communication component 484, and magnet array 486. Charging coil 482 of charging device 450 can transfer power to charging coil 442 of electronic device 410. Magnet array 446 of electronic device 410 can align with magnet array 486 of charging device 450. This alignment can help to align charging coil 442 and charging coil 482 to improve power transfer. Near-field communication component 444 and near-field communication component 484 can enable additional communications between electronic device 410 and charging device 450.

Charging coil 442 of electronic device 410 can include central opening 440. Antenna 420 can be positioned in central opening 440. A ferrite (not shown) can be positioned under charging coil 442. This ferrite can include an opening for antenna 420, or the ferrite can extend under some or all of antenna 420. Charging coil 482 of charging device 450 can include central opening 480. Antenna 460 can be positioned in central opening 480. A ferrite (not shown) can be positioned under charging coil 482. This ferrite can include an opening for antenna 460, or the ferrite can extend under some or all of antenna 460.

Antenna 420 in electronic device 410 can align with antenna 460 in charging device 450 when magnet array 446 in electronic device 410 is aligned with magnet array 486 in charging device 450. A single antenna 420 in electronic device 410 and a single antenna 460 in charging device 450 can provide a half-duplex path. That is, data can be transferred from charging device 450 to electronic device 410, and then from electronic device 410 to charging device 450 in an alternating fashion.

In these and other embodiments of the present invention, it can be desirable to have two data paths, one providing a receive path and one providing a transmit path for electronic device 410. Accordingly, electronic device 410 can include a second antenna 430 and charging device 450 can include a second antenna 470. Second antenna 430 and second antenna 470 can form a second data path between electronic device 410 and the charging device 450 when second antenna 430 and second antenna 470 are aligned. To facilitate the alignment between second antenna 430 and second antenna 470, second antenna 430 can be annular in shape such that second antenna 430 and second antenna 470 align regardless of the rotation of charging device 450 to electronic device 410. This can allow charging device 450 to be able to be oriented different ways at different angles with electronic device 410.

Antenna 420 and antenna 430 can be placed in other locations in electronic device 410. For example, antenna 420 and antenna 430 can be placed further away from each other. This can help to improve isolation between receive and transmit channels when one of antenna 420 and antenna 430 is receiving while the other is transmitting.

For example, antenna 420 and antenna 430 can both remain in central opening 440 with antenna 420 remaining centered in central opening 440. Antenna 420 and antenna 430 can be separated further apart by increasing a size of central opening 440, by decreasing a size of either or both antenna 420 and antenna 430, or by changing another dimension. In this configuration, a gap between antenna 420 and antenna 430 can be increased. To compensate, a spacing between antenna 460 and antenna 470 on charging device 450 can be increased as well. This arrangement can preserve rotational symmetry, allowing antenna 420 and antenna 430 of electronic device 410 and antenna 460 and antenna 470 of charging device 450 to be respectively mated at any rotational angle when magnet array 446 and magnet array 486 are aligned.

Alternatively, antenna 420 and antenna 430 can be placed further away from each other in central opening 440 of electronic device 410. For example, antenna 420 and antenna 430 can be on opposite sides of central opening 440. Antenna 430 can be made non-annular. To compensate, antenna 460 and antenna 470 can be on opposite sides of central opening 480 of charging device 450. Rotational symmetry could be sacrificed but mitigated by the addition of one or more alignment magnets as in the examples of FIG. 1 and FIG. 2. For example, an alignment magnet corresponding to alignment magnet 448 in electronic device 410 can be added to charging device 450 to provide a specific orientation that aligns antenna 420 to antenna 460 and antenna 430 to antenna 470.

Alternatively, antenna 420 can remain in central opening 440 while antenna 430 can be moved between charging coil 442 and magnet array 446 on electronic device 410. To maintain rotational symmetry, antenna 430 can be maintain a ring-shaped but larger and around charging coil 442. To compensate, antenna 460 can remain in central opening 480, while antenna 470 can be formed as a ring and positioned between charging coil 482 and magnet array 486. This arrangement can preserve rotational symmetry, allowing antenna 420 and antenna 430 of electronic device 410 and antenna 460 and antenna 470 of charging device 450 to be respectively mated at any rotational angle when magnet array 446 and magnet array 486 are aligned.

Alternatively, antenna 420 can remain in central opening 440 while antenna 430 can be moved outside of magnet array 446 on electronic device 410. To maintain rotational symmetry, antenna 430 can be maintained as a ring around magnet array 446. To compensate, antenna 460 can remain in central opening 480, while antenna 470 can be formed a ring and positioned around magnet array 486. This arrangement can preserve rotational symmetry, allowing antenna 420 and antenna 430 of electronic device 410 and antenna 460 and antenna 470 of charging device 450 to be respectively mated at any rotational angle when magnet array 446 and magnet array 486 are aligned.

Alternatively, both antenna 420 and antenna 430 can be moved outside of magnet array 446, for example on different sides of magnet array 446 on electronic device 410. To compensate, antenna 460 and antenna 470 can be moved outside of magnet array 486 to different sides of magnet array 486 on charging device 450. Antenna 430 can be made non-annular. Rotational symmetry could be sacrificed but mitigated by the addition of one or more alignment magnets as in the examples of FIG. 1 and FIG. 2. For example, an alignment magnet corresponding to alignment magnet 448 in electronic device 410 can be added to charging device 450 to provide a specific orientation that aligns antenna 420 to antenna 460 and antenna 430 to antenna 470.

In these and other embodiments of the present invention, electronic device 410 can include an opening 449 in magnet array 446 and near-field communication component 444 for the routing of wires 547 (shown in FIG. 5.) Charging device 450 can include a similar opening 489. Electronic device 410 can include alignment magnet 448 that can be used when aligning to larger charging devices 450.

FIG. 5 is a cutaway side view of an electronic device according to an embodiment of the present invention. Electronic device 510 can be similar to any of the electronic device 110 (shown in FIG. 1), electronic device 210 (shown in FIG. 2), electronic device 310 (shown in FIG. 3), or electronic device 410 (shown in FIG. 4.) Electronic device 510 can include an enclosure having a front side 514 and a backside 512. Front side 514 can include a screen. Backside 512 can form a charging surface that can mate with a corresponding charging device. Electronic device 510 can include coil 542 and magnet array 546. Antenna 520 can be located in opening 540 of coil 542. Ferrite 549 can be under coil 542 and can extend under opening 540. Ferrite 549 can extend partly or all the way under antenna 520. Electronic device 510 can further include near-field communication component 544 supported by frame 545. Ferrite 549 can include opening 543 for wires 547. Wires 547 can connect coil 542 to circuitry 541.

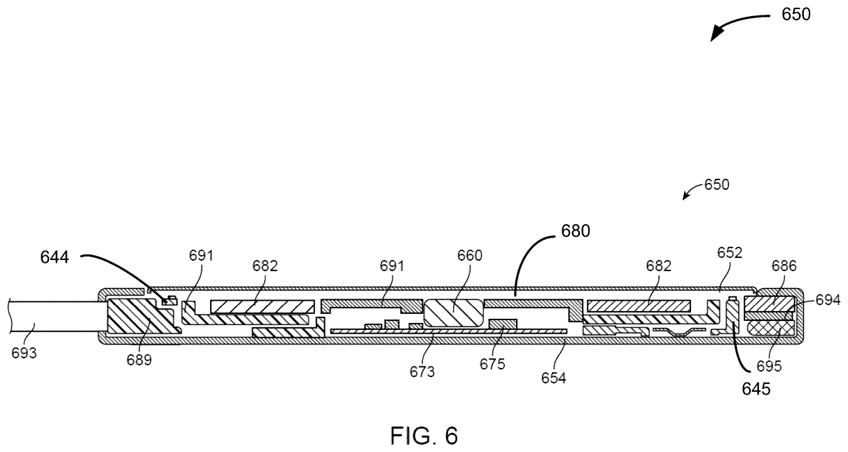

FIG. 6 is a cutaway side view of a charging device according to an embodiment of the present invention. Charging device 650 can be similar to any of the charging device 150 (shown in FIG. 1), charging device 250 (shown in FIG. 2), charging device 350 (shown in FIG. 3), or charging device 450 (shown in FIG. 4.) Charging device 650 can include enclosure having front side 652 and backside 654. Front side 652 can form a charging surface that can mate with a corresponding electronic device. Charging device 650 can include charging coil 682 and magnet array 686. Antenna 660 can be located in opening 680 in charging coil 682. Ferrite 691 can be under charging coil 682 and can extend under opening 680. Ferrite 691 can extend partly or all the way under antenna 660. Charging device 650 can further include near-field communication component 644 supported by frame 645. Cable 693 can couple conductors (not shown) to charging coil 682.

In these and other embodiments, near-field communication component 144 in electronic device 110 and near-field communication component 184 in charging device 150 (all shown in FIG. 1), as well as the corresponding near-field communication components in the other figures, can communicate at relatively low speeds, such as below 1 MHz data rates. The antenna such as antenna 120 in electronic device 110 and antenna 160 in charging device 150 (both shown in FIG. 1), as well as the corresponding antenna in FIG. 1 and the other figures, can communicate at relatively high speeds. For example, these antennas, shown collectively as antenna 700 below, can provide multilane traffic of 10 GB, 20 GB, 30 GB, 40 GB, 50 GB, 60 GB, or other data rates per lane.

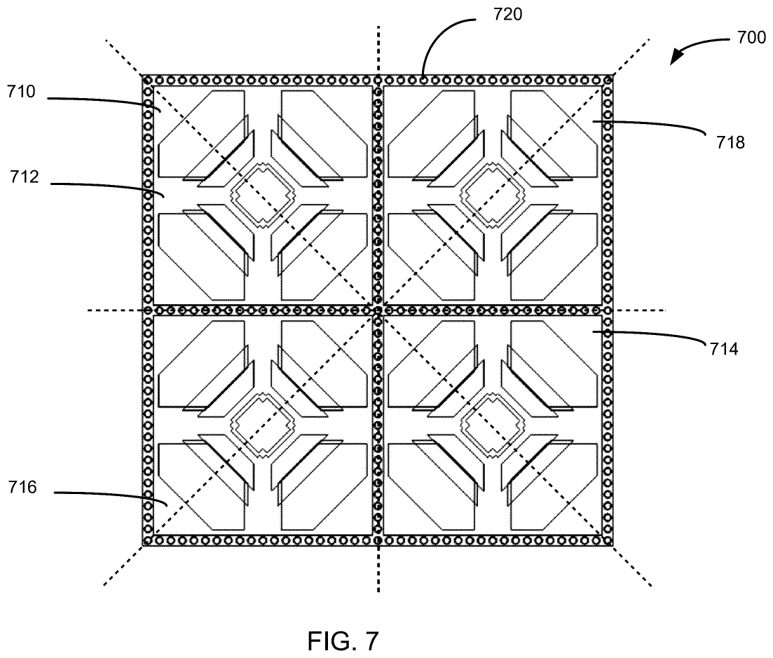

FIG. 7 illustrates an antenna according to an embodiment of the present invention. Antenna 700 can provide a compact antenna system for use in the electronic systems 100 (shown in FIG. 1), 200 (shown in FIG. 2), 300 (shown in FIG. 3), 400 (shown in FIG. 4), and other electronic systems. Antenna 700 can be used for half duplex, full duplex, or other type of communications. Antenna 700 can be a patch antenna or other type of antenna. Antenna 700 can support Near-Field communications, wireless Universal Serial Bus Type-C, Wi-Fi, or other high-speed wireless communications.

Four antenna elements 710 can be included in antenna 700. The antenna elements 710 can be circularly polarized with the same hand polarization, though antenna elements 710 can have different polarization in these and other embodiments of the present invention. Antenna 700 can provide a high isolation by incorporating geometrical symmetry. This can help to reduce a sensitivity to electromagnetic performance of the antenna elements.

Pairs of diagonally arranged antenna elements can operate in a differential feed configuration. Each pair can be used for transmitting or receiving. For example, antenna elements 712 and 714 can operate in a differential feed configuration, as can antenna elements 716 and 718.

Antenna 700 can be a multilayer antenna structure. Each antenna elements 710 can be separated with via wall 720. Connections to antenna 700 can be made using a stripline feed network. This stripline feed network can provide connections to the receive and transmit ports of antenna 700.

While antenna 700 is shown as being square, antenna 700 can have other shapes. For example, antenna 700 can be circular, annular, or antenna 700 can have other shapes. Antenna 700 can be used as any of the antennas described above or used in these and other embodiments of the present invention.

The antennas 700 and other components of the electronic systems shown herein can provide multilane traffic of 10 GB, 20 GB, 30 GB, 40 GB, 50 GB, 60 GB, or other data rates per lane.

The charging devices such as any of the charging device 150 (shown in FIG. 1), charging device 250 (shown in FIG. 2), charging device 350 (shown in FIG. 3), or charging device 450 (shown in FIG. 4), can be coupled to a host or other power adapter (not shown.)

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An electronic system comprising:
an electronic device comprising:
a housing;
a screen at a top side of the housing;
a first antenna proximate to a backside of the housing;
a wireless charging coil around the first antenna; and
a first magnet proximate to the wireless charging coil; and
a charging device comprising:
a housing;
a first antenna proximate to a front side of the housing;
a wireless charging coil around the first antenna; and
a first magnet proximate to the wireless charging coil.

2. The electronic system of claim 1 wherein the first antenna of the electronic device and the first antenna of the charging device are Near-Field antennas, each Near-Field antenna including four antenna elements arranged as a two-by-two array, where each antenna element is circularly polarized.

3. The electronic system of claim 2 wherein the electronic device further comprises a second antenna proximate to the backside of the housing and the charging device further comprises a second antenna proximate to the front side of the housing.

4. The electronic system of claim 3 wherein the second antenna of the electronic device is positioned proximate to the first antenna of the electronic device.

5. The electronic system of claim 4 wherein the second antenna of the charging device is annular shaped and laterally surrounds the first antenna of the charging device.

6. The electronic system of claim 5 wherein the first antenna and second antenna of the charging device can couple in an axisymmetric manner to the first antenna and second antenna of the electronic device.

7. The electronic system of claim 6 wherein the magnet of the electronic device comprises a magnet array around the coil of the electronic device and the magnet of the charging device comprises a magnet array around the coil of the charging device.

8. The electronic system of claim 3 wherein the electronic device further comprises a second antenna proximate to the backside of the housing and positioned such that the coil and magnet of the electronic device are between the first antenna and the second antenna of the electronic device, and the charging device further comprises a second antenna proximate to the front side of the housing and positioned such that the coil and magnet of the charging device are between the first antenna and the second antenna of the charging device.

9. The electronic system of claim 8 wherein the electronic device comprises a second magnet positioned such that the coil and magnet array of the electronic device are between the first antenna and the second magnet of the electronic device, and wherein the charging device comprises a second magnet positioned such that the coil and magnet array of the charging device are between the first antenna and the second magnet of the charging device.

10. The electronic system of claim 9 wherein when the electronic device and charging device are mated, the second magnet of the electronic device can attract the second magnet of the charging device such that the second antenna of the electronic device and the second antenna of the charging device are aligned.

11. The electronic system of claim 1 wherein the electronic device comprises a plurality of second magnets and a second antenna positioned such that the coil and magnet array of the electronic device are between the first antenna and the plurality of second magnets and the second antenna of the electronic device, and wherein the charging device comprises a second magnet and a plurality of second antennas positioned such that the coil and magnet array of the charging device are between the first antenna and the second magnet and plurality of second antennas of the charging device, and
wherein when the electronic device and charging device are mated, one of the plurality of second magnets of the electronic device can attract the second magnet of the charging device such that the second antenna of the electronic device and one of the plurality of the second antennas of the charging device are aligned.

12. The electronic system of claim 1 wherein the charging device comprises a plurality of second magnets and a second antenna positioned such that the coil and magnet array of the electronic device are between the first antenna and the plurality of second magnets and the second antenna of the charging device, and wherein the electronic device comprises a second magnet and a plurality of second antennas positioned such that the coil and magnet array of the electronic device are between the first antenna and the second magnet and plurality of second antennas of the electronic device, and
wherein when the electronic device and charging device are mated, one of the plurality of second magnets of the charging device can attract the second magnet of the electronic device such that the second antenna of the charging device and one of the plurality of the second antennas of the electronic device are aligned.

13. An electronic device comprising:
a housing;
a screen at a top side of the housing;
a first antenna proximate to a backside of the housing;
a wireless charging coil positioned laterally around the first antenna; and
a magnet array positioned laterally around the wireless charging coil.

14. The electronic device of claim 13 wherein the first antenna is a Near-Field antenna, the Near-Field antenna including four antenna elements arranged as a two-by-two array, where each antenna element is circularly polarized.

15. The electronic device of claim 14 further comprising a second antenna positioned proximate to the first antenna.

16. The electronic device of claim 14 further comprising a second antenna positioned such that the wireless charging coil and the magnet array are between the first antenna and the second antenna.

17. A charging device comprising:
a housing;
a first antenna proximate to a front side of the housing;
a wireless charging coil positioned laterally around the first antenna; and
a magnet array positioned laterally around the wireless charging coil.

18. The charging device of claim 17 wherein the first antenna is a Near-Field antenna, the Near-Field antenna including four antenna elements arranged as a two-by-two array, where each antenna element is circularly polarized.

19. The charging device of claim 18 further comprising a second antenna positioned proximate to the first antenna.

20. The charging device of claim 18 further comprising a second antenna positioned such that the wireless charging coil and the magnet array are between the first antenna and the second antenna.
